SEQUENCE LISTING (6 sequences)

SEQ ID NO: 1 - DNA, 21 bp, Artificial Sequence
  Synthetic
tagcttatcagactgatgttg

SEQ ID NO: 2 - DNA, 36 bp, Artificial Sequence
  Synthetic
cgcgatctcaacatcagtctgataagctagatcgcg

SEQ ID NO: 3 - DNA, 36 bp, Artificial Sequence
  Synthetic
cgcgatctctacttctgtgtgtaatgcaagatcgcg

SEQ ID NO: 4 - DNA, 21 bp, Artificial Sequence
  Synthetic
ttctacagtctgtgactcttg

SEQ ID NO: 5 - DNA, 35 bp, Artificial Sequence
  Synthetic
cgcgatccaagagtcacagactgtagaagatcgcg

SEQ ID NO: 6 - DNA, 35 bp, Artificial Sequence
  Synthetic
cgcgatccatgactctcacagtgaagatgatcgcg

(19) United States
(12) Patent Application Publication
(10) Pub. No.: US 2023/0324267 A1
(43) Pub. Date: Oct. 12, 2023

(54) DEVICE FOR REDUCING THE VOLUME OF A SAMPLE, A KIT COMPRISING THE SAME, AND USES THEREOF

(71) Applicant: Chung Yuan Christian University, Taoyuan City (TW)

(72) Inventors: Cheng-An LIN, Taoyuan City (TW); Rui-Hong HONG, Hsinchu City (TW); Chih-Chueh LU, New Taipei City (TW); Yi-Ning CHEN, Taoyuan City (TW)

(21) Appl. No.: 17/716,195

(22) Filed: Apr. 8, 2022

(51) Int. Cl. G01N 1/40; B01L 3/00

(52) U.S. Cl. CPC G01N 1/4022; B01L 3/502792; G01N 2001/4027; B01L 2200/0642; B01L 2300/0829; B01L 2300/161; B01L 2200/12; B01L 2400/088

(57) ABSTRACT

Disclosed herein is a device for reducing the volume of an aquatic sample, comprising, a substrate; a metal layer disposed above the substrate; a hydrophobic layer disposed above the metal layer having a plurality of assay wells formed therein; and a hydrophilic layer coated on each of the plurality of assay wells. Also encompassed in the present disclosure are a kit comprising the device and a lipoplex containing a liposome and a fluorescence-labeled molecular beacon inside the liposome, and use of the kit in detecting a target nucleic acid in a biological sample.

### SEQUENCE LISTING

The present application is being filed along with a Sequence Listing in electronic format. The Sequence Listing is provided as a file entitled “MYHP_0038US_SeqList_20220318_filed_1”, created Apr. 8, 2022, which is 2 KB in size. The information in the electronic format of the Sequence Listing is incorporated herein by reference in its entirety.

### BACKGROUND OF THE INVENTION

### 1. Field of the Invention

The present disclosure in general relates to the field of bioassay. More particularly, the present disclosure relates to devices and methods for detecting nucleic acids, particularly, nucleic acids that are in trace amounts.

### 2. Description of Related Art

The sensitivity and specificity of nucleic acid (e.g., DNA) detection may decrease when the target nucleic acid is in very low abundance. To effectively detect trace amounts of target nucleic acid in a sample, we have developed devices and methods that significantly reduce the volume of the sample, which contains target nucleic acids, to pico-liter level thereby magnifying the concentration of the target nucleic acid in the sample to a level that can be easily detected.

### SUMMARY

The following presents a simplified summary of the disclosure in order to provide a basic understanding to the reader. This summary is not an extensive overview of the disclosure and it does not identify key/critical elements of the present invention or delineate the scope of the present invention. Its sole purpose is to present some concepts disclosed herein in a simplified form as a prelude to the more detailed description that is presented later.

As embodied and broadly described herein, one aspect of the present disclosure is directed to a device for reducing the volume of an aquatic sample (e.g., an aquatic sample containing nucleic acids therein). The device comprises:

a substrate;

a metal layer disposed above the substrate;

a hydrophobic layer disposed above the metal layer having a plurality of assay wells formed therein; and

a hydrophilic layer coated on each of the plurality of assay wells;

wherein

the aquatic sample tends to flow toward the plurality of assay wells and stay therein, thereby resulting in a reduction of the volume of the aquatic sample to picoliter (pl) level after concentrating the aquatic sample for a sufficient period of time.

According to the embodiments of the present disclosure, the metal layer is formed by sputter deposition the substrate with metal atoms, and the metal atoms are derived from a metal selected from the group consisting of ruthenium (Ru), rhodium (Rh), palladium (Pd), osmium (Os), iridium (Ir), platinum (Pt), silver (Ag), copper (Cu), rhenium (Re), mercury (Hg), and gold (Au). According to some preferred embodiments, the metal atoms are derived from gold.

According to the embodiments of the present disclosure, the hydrophobic layer is formed by spin coating the substrate with a hydrophobic polymer, and the hydrophobic polymer is selected from the group consisting of polyethylene, poly(isobutene), poly(isoprene), poly(4-methyl-1-pentene), polypropylene, a copolymer of ethylene and propylene, a copolymer of ethylene, propylene, and hexadiene, a copolymer of ethylene and vinyl acetate, a copolymer of ethylene and butene, a copolymer of ethylene and octene, poly(styrene), poly(2-methylstyrene), poly(vinyl butyrate), poly(vinyl decanoate), poly(vinyl dodecanoate), poly(vinyl hexadecanoate), poly(vinyl hexanoate), poly(vinyl octanoate), poly(methacrylonitrile), poly(n-butyl acetate), poly(ethyl acrylate), poly(benzyl methacrylate), poly(n-butyl methacrylate), poly(isobutyl methacrylate), poly(t-butyl methacrylate), poly(t-butylaminoethyl methacrylate), poly(do-decyl methacrylate), poly(ethyl methacrylate), poly(2-ethylhexyl methacrylate), poly(n-hexyl methacrylate), poly(phenyl methacrylate), poly(n-propyl methacrylate), poly(octadecyl methacrylate), poly(ethylene terephthalate), poly(butylene terephthalate), polybutylene, polyacetylene, and fluoropolymer. According to some preferred embodiments, the hydrophobic polymer is fluoropolymer.

According to the embodiments of the present disclosure, the hydrophilic layer is formed by coating each of the plurality of assay wells with a layer of a hydrophilic polymer, and the hydrophilic polymer is selected from the group consisting of polyurethane, polyvinyl alcohol, polypropylene oxide, polyethylene oxide, polytetramethyl oxide, polyvinyl pyridine, polyvinyl pyrrolidone, polyacrylonitrile, polyacrylamide, a copolymer of polyvinyl pyrrolidone and polyvinyl acetate, sulfonated polystyrene, a copolymer of polyvinyl pyrrolidone and polystyrene, dextran, mucopolysaccharide, xanthan, hydroxypropyl cellulose, methyl cellulose, hyaluronic acid, polyacrylic acid, polymethacrylic acid, polyhydroxyethyl methacrylate, chitosan, polyethylene imine, polyacrylamide, polyethylene glycol, polylactic acid, polystyrene sulfonic acid, polyanetholesulfonic acid, spermine, spermidine, putrescine, collagen, elastin, fibronectin, polysarcosine, poly(2-methacryloyloxyethyl phosphorylcholine) (PMPC), and heparin.

According to the embodiments of the present disclosure, the substrate is made from a material such as silica, glass, ceramic, and a metal.

According to some preferred embodiments, the substrate is treated with a sulfur functional trialkoxy silane or with Ultraviolet (UV) prior to being sputter deposited with the metal atoms. Examples of said sulfur functional trialkoxy silane include, but are not limited to, 3-aminopropyltrimethoxysilane, 3-aminopropyltriethoxysilane, 3-mercaptopropyltrimethoxysilane, 3-mercaptopropyltriethoxysilane (MPTES), 3-aminopropyltrichlorosilane, and 3-mercaptopropyltrichlorosilane. In one specific example, the substrate is treated with UV prior to being sputter deposited with the gold atoms.

Further, the metal layer formed by sputter depositing the substrate with the gold atoms is about 20 nm in thickness.

According to some preferred embodiments of the present disclosure, each of the plurality of assay wells is formed by laser etching the hydrophobic layer thereby creating the well that is about 5-50 μm in diameter. Further, the well has an aspect ratio of 1:0.1-1:2.

Preferably, prior to being coated with the hydrophilic layer, the surface of each of the plurality of assay wells is treated with an amino silane, for example, (3-aminopropyl)triethoxysilane (APTES), (3-aminopropyl)trimethoxysilane (APTMS), N-(2-aminoethyl)-3-aminopropyltrimethoxysilane (AE-APTMS), bis[(3-triethoxysily)propyl]amine, bis[(3-trimethoxysilyl)propyl]amine, 3-aminopropylmethyldiethoxysilane, 3-aminopropylmethyldimethoxysilane, N-[3-(trimethoxysilyl)propyl]ethylenediamine (DAS), aminoethylaminopropyltriethoxysilane, aminoethylaminopropylmethyldimethoxysilane, aminoethylaminopropylmethyldiethoxysilane, aminoethylaminomethyltriethoxysilane, aminoethylaminomethylmethyldiethoxysilane, diethylenetriaminopropyltrimethoxysilane, diethylenetriaminopropyltriethoxysilane, diethylenetriaminopropylmethyldimethoxysilane, diethyleneaminomethylmethyldiethoxysilane, (N-phenylamino)methyltrimethoxysilane, (N-phenylamino)methyltriethoxysilane, (N-phenylamino)methylmethyldimethoxysilane, (N-phenylamino)methylmethyldiethoxysilane, 3-(N-phenylamino)propyltrimethoxysilane, 3-(N-phenylamino)propyltriethoxysilane, 3-(N-phenylamino)propylmethyldimethoxysilane, 3-(N-phenylamino)propylmethyldiethoxysilane, or N-(N-butyl)-3-aminopropyltrimethoxysilane. In one working example, the surface of each of the plurality of assay wells is treated with APTMS prior to being coated with the hydrophilic layer.

Preferably, the hydrophilic layer or the layer of polysarcosine coated on each of the plurality of assay wells is formed by polymerizing a plurality of sarcosine-N-carboxyanhydride (Sar-NCA) monomers. Alternatively or optionally, the hydrophilic layer or the PMPC coated on each of the plurality of assay wells is formed by polymerizing a plurality of 2-methacryloyloxyethyl phosphorylcholine (MPC) monomers. Alternatively or optionally, the hydrophilic layer or the heparin coated on each of the plurality of assay wells is formed by polymerizing a plurality of disaccharide units selected from the group consisting of 2-O-sulfo-α-L-iduronic acid and 2-deoxy-2-sulfamido-α-D-glucopyranosl-6-O-sulfate (IdoA(2S)-G1cNS(6S)); β-D-glucuronic acid and 2-deoxy-2-acetamido-α-D-glucopyranosyl (G1cA-G1cNAc); β-D-glucuronic acid and 2-deoxy-2-sulfamido-α-D-glucopyranosyl (G1cA-G1cNS); α-L-iduronic acid and 2-deoxy-2-sulfamido-α-D-glucopyranosyl (IdoA-G1cNS); 2-O-sulfo-α-L-iduronic acid and 2-deoxy-2-sulfamido-α-D-glucopyranosyl (IdoA(2S)-G1cNS); and α-L-iduronic acid and 2-deoxy-2-sulfamido-α-D-glucopyranosl-6-O-sulfate (IdoA-G1cNS (6S)).

Also encompassed in the present disclosure is a method for producing the foregoing device (hereafter the “manufacturing method”). Said method comprises the steps of,

(a) providing a substrate;

(b) forming a metal layer by sputter deposition the substrate with metal atoms;

(c) forming a hydrophobic layer on the metal layer by spin coating the metal layer with a hydrophobic polymer;

(d) laser etching the hydrophobic layer of the step (c) to create a plurality of assay wells therein; and

(e) coating each of the plurality of assay wells with a layer of a hydrophilic polymer to form a hydrophilic layer thereon, thereby producing the present device.

According to some embodiments of the present disclosure, in the present device, each of the plurality of assay wells is about 5-50 μm in diameter and has an aspect ratio of 1:0.1-1:2.

In some embodiments of the present disclosure, the present manufacturing method further comprises, prior to step (b), the step of,

(a-1) treating the substrate with a sulfur functional trialkoxy silane or with UV.

Exemplary sulfur functional trialkoxy silane includes, but is not limited to, 3-aminopropyltrimethoxysilane, 3-aminopropyltriethoxysilane, 3-mercaptopropyltrimethoxysilane, 3-mercaptopropyltriethoxysilane (MPTES), 3-aminopropyltrichlorosilane, and 3-mercaptopropyltrichlorosilane.

In some embodiments of the present disclosure, the present manufacturing method further comprises, prior to step (e), the step of,

(d-1) treating the surface of each of the plurality of assay wells with an amino silane.

The amino silane suitable for use in the present manufacturing method may be (3-aminopropyl)triethoxysilane (APTES), (3-aminopropyl)trimethoxysilane (APTMS), N-(2-aminoethyl)-3-aminopropyltrimethoxysilane (AE-APTMS), bis[(3-triethoxysily)propyl]amine, bis[(3-trimethoxysilyl)propyl]amine, 3-aminopropylmethyldiethoxysilane, 3-aminopropylmethyldimethoxysilane, N-[3-(trimethoxysilyl)propyl]ethylenediamine (DAS), aminoethylaminopropyltriethoxysilane, aminoethylaminopropylmethyldimethoxysilane, aminoethylaminopropylmethyldiethoxysilane, aminoethylaminomethyltriethoxysilane, aminoethylaminomethylmethyldiethoxysilane, diethylenetriaminopropyltrimethoxysilane, diethylenetriaminopropyltriethoxysilane, diethylenetriaminopropylmethyldimethoxysilane, diethyleneaminomethylmethyldiethoxysilane, (N-phenylamino)methyltrimethoxysilane, (N-phenylamino)methyltriethoxysilane, (N-phenylamino)methylmethyldimethoxysilane, (N-phenylamino)methylmethyldiethoxysilane, 3-(N-phenylamino)propyltrimethoxysilane, 3-(N-phenylamino)propyltriethoxysilane, 3-(N-phenylamino)propylmethyldimethoxysilane, 3-(N-phenylamino)propylmethyldiethoxysilane, or N-(N-butyl)-3-aminopropyltrimethoxysilane.

According to some embodiments of the present disclosure, the polysarcosine hydrophilic layer of the present device is formed by polymerizing a plurality of Sar-NCA monomers. According to other embodiments of the present disclosure, the PMPC hydrophilic layer is formed by polymerizing a plurality of MPC monomers. According to further embodiments of the present disclosure, the heparin hydrophilic layer is formed by polymerizing a plurality of disaccharide units selected from the group consisting of 2-O-sulfo-α-L-iduronic acid and 2-deoxy-2-sulfamido-α-D-glucopyranosyl-6-O-sulfate (IdoA(2S)-G1eNS(6S)); β-D-glucuronic acid and 2-deoxy-2-acetamido-α-D-glucopyranosyl (G1cA-G1cNAc); β-D-glucuronic acid and 2-deoxy-2-sulfamido-α-D-glucopyranosyl (G1cA-G1cNS); α-L-iduronic acid and 2-deoxy-2-sulfamido-α-D-glucopyranosyl (IdoA-G1cNS); 2-O-sulfo-α-L-iduronic acid and 2-deoxy-2-sulfamido-α-D-glucopyranosyl (IdoA(2S)-G1cNS); and α-L-iduronic acid and 2-deoxy-2-sulfamido-α-D-glucopyranosyl-6-O-sulfate (IdoA-G1cNS (6S)).

Another aspect of the present disclosure is directed to a method for reducing the volume of an aquatic sample (e.g., an aquatic sample containing nucleic acids therein) by use of the present device, following the steps of,

(a) applying the aquatic sample onto each of the plurality of assay wells of the device; and

(b) concentrating the aquatic sample for a sufficient period of time, thereby resulting in reducing the volume of the aquatic sample;

wherein

the aquatic sample is labeled with a fluorescence dye or a fluorescent nanomaterial.

Alternatively or in addition, the concentrated aquatic sample of step (b) may be analyzed by any one of a reflection microscope, a transmission microscope, a fluorescence microscope, an upright microscope, an inverted microscope, a dark-field microscope, a confocal microscope, a standing wave confocal microscope, a reflection contrast microscope, or a fluorescence scanner.

Exemplary fluorescence dye includes, but is not limited to, N-hydroxysuccinimide (NHS) ester (ATTO425, ATTO647, ATTO655), maleimide (ATTO550, ATTO647N), biotin (ATTO565), phosphoramidite (CALFluorGold540, Quasar570, Quasar670), amidite (CALFluorOrange560, Quasar705), carboxylic acid (CALFluorRed590), 6-carboxyfluorescein (6-FAM), 6-carboxy-X-rhodamine (ROX), rhodamine 6G (R6G), cyanine 3 (Cy3), cyanine 3.5 (Cy3.5), cyanine 5 (Cy5), cyanine 5.5 (Cy5.5), 5′-dichloro-dimethoxy-fluorescein (JOE), fluorescein, hexachloro-fluorescein (HEX), succinimidyl ester (AlexaFluor350), tetrachloro-fluorescein (TET), tetramethylrhodamine (TAMRA), Texas red, Victoria (VIC), and Yakima yellow.

Said fluorescent nanomaterial suitable for use in the present method may be fluorescent nanoparticles, fluorescent nanoclusters, carbon quantum dots, copper germanium sulfide quantum dots, antimony-containing organic-inorganic perovskite quantum dots, gold quantum dots, cadmium telluride quantum dots, lead sulfide quantum dots, cadmium selenide/zinc sulfide quantum dots, zinc cadmium selenide/zinc sulfide quantum dots, cadmium selenide/cadmium sulfide quantum dots, zinc selenide/zinc sulfide quantum dots, cadmium selenide sulfide quantum dots, or cadmium sulfide quantum dots.

In the present method, the concentrating step (b) may be achieved by methods such as evaporation, heating, vacuum concentration, and the like.

According to embodiments of the present disclosure, the aquatic sample may be a biological sample isolated from a subject (e.g., a mammal; preferably, a human). Examples of the biological sample include, but are not limited to, blood, plasma, serum, saliva, sputum, urine, and tissue lysate.

Another aspect of the present disclosure is directed to a kit comprising the present device and a lipoplex, wherein the lipoplex comprises a liposome and a molecular beacon (MB) inside the liposome, and the MB is labeled with a fluorescence dye and a quencher.

The fluorescence dye suitable for use in labeling the MB may be N-hydroxysuccinimide (NHS) ester (ATTO425, ATTO647, ATTO655), maleimide (ATTO550, ATTO647N), biotin (ATTO565), phosphoramidite (CALFluorGold540, Quasar570, Quasar670), amidite (CALFluorOrange560, Quasar705), carboxylic acid (CALFluorRed590), 6-carboxyfluorescein (6-FAM), 6-carboxy-X-rhodamine (ROX), rhodamine 6G (R6G), cyanine 3 (Cy3), cyanine 3.5 (Cy3.5), cyanine 5 (Cy5), cyanine 5.5 (Cy5.5), 5′ -dichloro-dimethoxy-fluorescein (JOE), fluorescein, hexachloro-fluorescein (HEX), succinimidyl ester (AlexaFluor350), tetrachloro-fluorescein (TET), tetramethylrhodamine (TAMRA), Texas red, Victoria (VIC), or Yakima yellow.

Examples of the quencher suitable for use in the present kit include, but are not limited to, black hole quencher 1 (BHQ1), black hole quencher 2 (BHQ2), black hole quencher 3 (BHQ3), minor groove binder (MGB), nonfluorescent quencher (NFQ), Dabcyl (4-(4′-dimethylaminophenylazo)benzoic acid), onyx quencher A (OQA), onyx quencher B (OQB), onyx quencher C (OQC), and onyx quencher D (OQD).

According to preferred embodiments of the present disclosure, the MB comprises a nucleic acid having a polynucleotide sequence of SEQ ID NO.: 2 or SEQ ID NO.: 5.

A further aspect of the present disclosure is pertaining to a method of detecting a target nucleic acid in a biological sample isolated from a subject by using the foregoing kit. The method comprises the steps of,

(a) mixing the lipoplex with the biological sample thereby forming a mixture;

(b) applying the mixture of the step (a) onto each of the plurality of assay wells of the device; and

(c) reducing the volume of the mixture disposed in each of the plurality of assay wells of the step (b) via evaporation, heating, or vacuum concentration;

wherein

the fluorescence signal emitted from the MB indicates the presence of the target nucleic acid within the biological sample.

According to some embodiments of the present disclosure, the biological sample may be blood, plasma, serum, saliva, sputum, urine, or tissue lysate; and the subject is a human.

According to one preferred embodiment of the present disclosure, the target nucleic acid is present in an extracellular vesicle (EV).

Many of the attendant features and advantages of the present disclosure will becomes better understood with reference to the following detailed description considered in connection with the accompanying drawings.

### BRIEF DESCRIPTION OF THE DRAWINGS

These and other features, aspects and advantages of the present invention will become better understood with reference to the following description, appended claims and the accompanying drawings, where:

FIG. 1A is a multi-layer structure for use in constructing the present device in accordance with one preferred embodiment of the present disclosure;

FIG. 1B is the cross-sectional view of the multi-layer structure of FIG. 1A after being laser etched to form a plurality of recesses;

FIG. 1C is the cross-sectional view of the multi-layer structure of FIG. 1B after each of the plurality of recesses has been coated with a hydrophilic layer;

FIG. 2 is a schematic diagram illustrating the process of concentrating an aquatic sample by using the present device: panel A, at the beginning of the concentration; panel B, in the early-middle stage of the concentration; panel C, in the middle of the concentration; panel D, at the end of the concentration;

FIG. 3 is the perspective view of the schematic diagram of FIG. 2, in which panel A depicts the early-middle stage of the concentration, the stage corresponding to FIG. 2, panel B; panel B depicts the middle stage of the concentration, the stage corresponding to FIG. 2, panel C; panel C depicts the end stage of the concentration, the stage corresponding to FIG. 2, panel D; and

FIG. 4 depicts the fluorescence intensity emitted from the lipoplexes (LXs) containing the miR-21 MBs at the indicated volume with or without reaction with the neutrally charged liposomes (nLPs) containing the miR-21 fragments in accordance with one embodiment of the present disclosure.

In accordance with common practice, the various described features/elements are not drawn to scale but instead are drawn to best illustrate specific features/elements relevant to the present invention. Also, like reference numerals and designations in the various drawings are used to indicate like elements/parts.

### DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

### I. Definition

For convenience, certain terms employed in the specification, examples and appended claims are collected here. Unless otherwise defined herein, scientific and technical terminologies employed in the present disclosure shall have the meanings that are commonly understood and used by one of ordinary skill in the art. Also, unless otherwise required by context, it will be understood that singular terms shall include plural forms of the same and plural terms shall include the singular. Specifically, as used herein and in the claims, the singular forms “a,” “an,” and “the” include the plural reference unless the context clearly dictates otherwise. Also, as used herein and in the claims, the terms “at least one” and “one or more” have the same meaning and include one, two, three, or more.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in the respective testing measurements. Also, as used herein, the term “about” generally means within 10%, 5%, 1%, or 0.5% of a given value or range. Alternatively, the term “about” means within an acceptable standard error of the mean when considered by one of ordinary skill in the art. Other than in the operating/working examples, or unless otherwise expressly specified, all of the numerical ranges, amounts, values and percentages such as those for quantities of materials, durations of times, temperatures, operating conditions, ratios of amounts, and the likes thereof disclosed herein should be understood as modified in all instances by the term “about”. Accordingly, unless indicated to the contrary, the numerical parameters set forth in the present disclosure and attached claims are approximations that can vary as desired. At the very least, each numerical parameter should at least be construed in light of the number of reported significant digits and by applying ordinary rounding techniques.

The terms “hydrophilic” and “hydrophobic” are defined by the measurement result of the contact angle, and the measurement is usually done by a contact angle meter. The “contact angle” (θ) refers to the angle formed through the three-phase point of solid, liquid and gas contact along the tangent direction of the liquid/gas interface when a liquid is in contact with a solid (the angle through the inside of the liquid). Thus, the term “hydrophilic” is characterized by the contact angle for the droplet onto the surface of less than 90°, which means that the droplet wets the surface; and the term “hydrophobic” is characterized by the contact angle for the droplet onto the surface of greater than 90°, which means that the droplet does not wet the surface.

The term “aspect ratio” as used herein refers to a ratio of the diameter of an assay well of the present device to the height of the assay well, in which the height of the assay well is the thickness of the hydrophobic layer of the present device.

As used herein, the term “lipoplex” means any positively charged liposome-nucleic acid complexes generally formed between a lipid (or a mixture of lipids with a final positive charge) and a nucleic acid (e.g., a target nucleic, MB, or a combination thereof), for detecting a target nucleic acid.

The term “liposome” as used herein means any vesicles consisting of a hydrophilic core enclosed by at least one lipid layer.

The term “molecular beacon (MB)” as used herein refers to a single-stranded oligonucleotide probe that forms a stem-and-loop structure (or a hairpin-like structure). The loop contains a probe sequence that is complementary to a target nucleic acid sequence, and the stem is formed by annealing complementary “arm” sequences that are located at either side of the probe sequence. In the present disclosure, a MB is dual-labeled, with a fluorophore labeled at one end and a quencher labeled at the other end, and the fluorophore is internally quenched and is restored when MB has bond to a target nucleic acid sequence.

As used herein, the term “extracellular vesicle (EV)” refers to all vesicles released from cells by any mechanism, therefore including secreted and exocytosed vesicles, thereby encompassing exosomes, but also including vesicles released by ectosytosis, reverse budding, fission of membrane(s) (as, for example, multivesicular endosomes, ectosomes, microvesicles and microparticles, etc.), and release of apoptotic bodies and hybrid vesicles containing acrosomal and sperm plasma membrane components. The EV is composed of a lipid bilayer composed of a cell membrane component, cell membrane lipids, membrane proteins, genetic material, and cytoplasmic components of the cell.

The term “subject” refers to an animal including the human species and is intended to include both the male and female gender unless one gender is specifically indicated. Accordingly, the term “subject” encompasses any mammal which may benefit from using the present device/kit/method. Examples of a “subject” include, but are not limited to, a human, rat, mouse, guinea pig, monkey, pig, goat, cow, horse, dog, cat, bird and fowl. In an exemplary embodiment, the subject is a human.

### II. Description of the Invention

The present disclosure pertains to a device having a plurality of assay wells formed thereon independently for reducing the volume of an aquatic sample to pico-liter level. The present device takes advantage on the differences between the hydrophilicity and hydrophobicity in and out of the assay well that houses the aquatic sample, in which the assay well is coated with a hydrophilic layer, while the rest of the device (i.e., the part that is outside the assay wells) is coated with a hydrophobic layer; the hydrophilicity/hydrophobicity differences thus results in the tendency for the aquatic sample to flow toward the wells and stay therein, leading to concentration of the aquatic sample with the volume of the aquatic sample being lowered to pico-liter level. The device is particularly useful in detecting a trace molecule within the aquatic sample, as the concentration of the sample would lead to amplification and detection of the trace molecule.

1. The Present Device and Uses Thereof

Accordingly, it is the first aspect of the present disclosure to provide a device for reducing the volume of an aquatic sample. The device comprises:

a substrate;

a metal layer disposed above the substrate;

a hydrophobic layer disposed above the metal layer having a plurality of assay wells formed therein; and

a hydrophilic layer coated on each of the plurality of assay wells;

wherein

the aquatic sample tends to flow toward the plurality of assay wells and stay therein, thereby resulting in a reduction of the volume of the aquatic sample to picoliter level after concentrating the aquatic sample for a sufficient period of time.

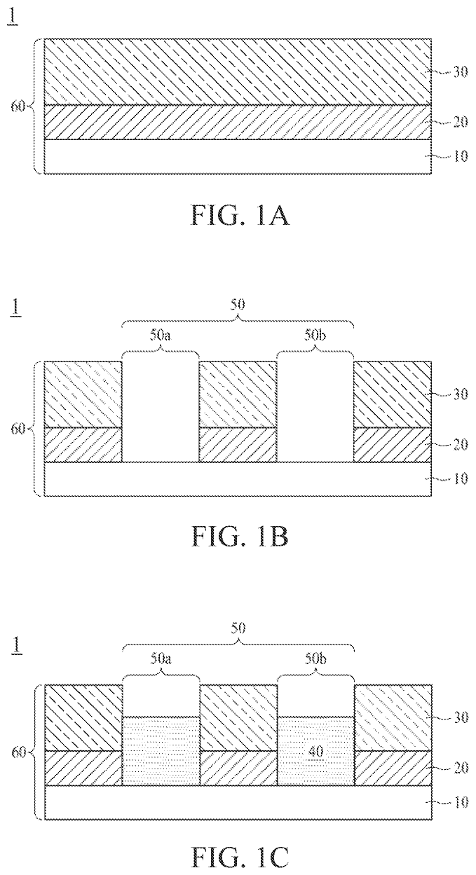

References are made to FIGS. 1A to 1C, in which FIG. 1A is a multi-layer structure for constructing the present device 1; FIG. 1B is the cross-sectional view of the multi-layer structure in FIG. 1A after being etched to form a plurality of recesses thereon; and FIG. 1C is a cross-sectional view of the multi-layer structure of FIG. 1B after each of the plurality of recesses has been coated with a hydrophilic layer.

To construct the present device 1, a metal layer 20 and a hydrophobic layer 30 are sequentially deposited on top of a substrate 10 to form a multi-layer structure 60 (FIG. 1A). The multi-layer structure 60 is then etched to form a plurality of recesses (50a, 50b, and etc.) therein, in which the material in the designated areas is removed by etching until the underlying substrate 10 is exposed (FIG. 1B). Then, each of the plurality of recesses (50a, 50b, and etc.) is coated with a layer of hydrophilic material (i.e., a hydrophilic layer 40) thereby forming a plurality of assay wells 50 (FIG. 1C), in which each assay wells 50 is suitable for reducing volume of an aquatic sample.

Examples of the material suitable for serving as the substrate 10 include, but are not limited to, silica, glass, ceramic, metal, and the like. Preferably, the substrate 10 is made of glass. Before construction, the substrate 10 is cleaned by washing its surface with distilled water, 70-95% alcohol, or commercially available surface cleansers (e.g., First Contact™ cleaning solution), to remove any lint or impurities present on the surface.

Additionally or optionally, the surface of the cleansed substrate 10 is further modified to facilitate the deposition of subsequent layers (e.g., a metal layer). To this purpose, the substrate 10 is treated with a sulfur functional trialkoxy silane so as to confer the surface of the substrate 10 with thiol groups (—SH); alternatively, the substrate 10 is treated with a UV light at specified wavelength (e.g., 185 nm or 254 nm) so as to confer the surface of the substrate 10 with hydroxyl groups. Exemplary sulfur functional trialkoxy silane includes, but is not limited to, 3-aminopropyltrimethoxysilane, 3-aminopropyltriethoxysilane, 3-mercaptopropyltrimethoxysilane, 3-mercaptopropyltriethoxysilane (MPTES), 3-aminopropyltrichlorosilane, and 3-mercaptopropyltrichlorosilane.

According to preferred embodiments of the present disclosure, the substrate 10, preferably being cleansed and modified as described above, is sputter deposited with a layer of metal atoms (e.g., the gold atoms), thereby forming a metal layer 20 about 5-50 nm in thickness, such as 5, 10, 15, 20, 25, 30, 35, 40, 45, or 50 nm in thickness; preferably, about 10-45 nm in thickness, such as 10, 15, 20, 25, 30, 35, 40 or 45 nm in thickness; more preferably, about 20 nm in thickness. The metal layer serves the function of positioning and energizing the subsequent UV laser etching, thereby assisting the formation of a plurality of recesses (50a, 50b, and etc.) within a hydrophobic layer 30. Said positioning may be achieved by locating the area where the metal layer is absent due to removal by UV laser etching, which facilitates subsequent identification of the formed recesses. Exemplary metal suitable as the source of metal atoms for use in the present device include, but are limited to, ruthenium (Ru), rhodium (Rh), palladium (Pd), osmium (Os), iridium (Ir), platinum (Pt), silver (Ag), copper (Cu), rhenium (Re), mercury (Hg), and gold (Au). Preferably, the metal suitable as the source of metal atoms for use in the present device is gold.

Then, a hydrophobic layer 30 is spin coated on top of the metal layer 20. To this purpose, hydrophobic polymers are spin-coated on top of the metal layer 20 at a speed of 1,000-10,000 revolutions per minute (r.p.m.), such as 1,000, 1,500, 2,500, 3,500, 4,500, 5,500, 6,500, 7,500, 8,500, 9,500, 10,000 and 10,500 r.p.m, thereby forming the hydrophorbic layer 30, which is about 0.1-50 μtm in thickness, such as 0.1, 0.2, 0.3, 0.4, 0.5, 0.6, 0.7, 0.8, 0.9, 1, 1.5, 2, 2.5, 3, 3.5, 4, 4.5, 5, 5.5, 6, 6.5, 7, 7.5, 8, 8.5, 9, 9.5, 10, 12.5, 15, 17.5, 20, 22.5, 25, 27.5, 30, 32.5, 35, 37.5, 40, 42.5, 45, 47.5, or 50 μm in thickness; preferably, about 0.5-30 μm in thickness, such as 0.5, 0.6, 0.7, 0.8, 0.9, 1, 1.5, 2, 2.5, 3, 3.5, 4, 4.5, 5, 5.5, 6, 6.5, 7, 7.5, 8, 8.5, 9, 9.5, 10, 12.5, 15, 17.5, 20, 22.5, 25, 27.5, or 30 μm in thickness; more preferably, about 5-10 μm in thickness, such as 5, 5.5, 6, 6.5, 7, 7.5, 8, 8.5, 9, 9.5, 10 μm in thickness.

Examples of the hydrophobic polymer suitable for use in the present disclosure include, but are not limited to, polyethylene, poly(isobutene), poly(isoprene), poly(4-methyl-1-pentene), polypropylene, a copolymer of ethylene and propylene, a copolymer of ethylene, propylene, and hexadiene, a copolymer of ethylene and vinyl acetate, a copolymer of ethylene and butene, a copolymer of ethylene and octene, poly(styrene), poly(2-methylstyrene), poly(vinyl butyrate), poly(vinyl decanoate), poly(vinyl dodecanoate), poly(vinyl hexadecanoate), poly(vinyl hexanoate), poly(vinyl octanoate), poly(methacrylonitrile), poly(n-butyl acetate), poly(ethyl acrylate), poly(benzyl methacrylate), poly(n-butyl methacrylate), poly(isobutyl methacrylate), poly(t-butyl methacrylate), poly(t-butylaminoethyl methacrylate), poly(do-decyl methacrylate), poly(ethyl methacrylate), poly(2-ethylhexyl methacrylate), poly(n-hexyl methacrylate), poly(phenyl methacrylate), poly(n-propyl methacrylate), poly(octadecyl methacrylate), poly(ethylene terephthalate), poly(butylene terephthalate), polybutylene, polyacetylene, and fluoropolymer. According to some preferred embodiments of the present disclosure, the hydrophobic layer is formed by fluoropolymer (e.g., poly(tetrafluoroethene) (PTFE, Teflon) or poly(perfluoro-4-vinyloxy-1-butene) (CYTOP™)).

Following the formation of the hydrophobic layer 30 described above, the hydrophobic layer 30 in pre-designated areas are removed by laser etching (e.g., UV laser etching) thereby forming a plurality of recesses (50a, 50b, and etc.). In some embodiments, only part of the hydrophobic layer 30 in the pre-designated area is removed; while in other embodiments, all of the hydrophobic layer 30 in the pre-designated area is removed, in such case, the etching does not stop until the underneath substrate 10 is exposed. Then, each recess (50a, 50b, and etc.) is further coated with a hydrophilic layer 40 thereby forming a plurality of assay wells 50 suitable for reducing the volume of an aquatic sample.

The hydrophilic layer 40 may be formed by polymerizing a plurality of a hydrophilic polymer; without intending to be bound by theory, such hydrophilic polymer may be polyurethane, polyvinyl alcohol, polypropylene oxide, polyethylene oxide, polytetramethyl oxide, polyvinyl pyridine, polyvinyl pyrrolidone, polyacrylonitrile, polyacrylamide, a copolymer of polyvinyl pyrrolidone and polyvinyl acetate, sulfonated polystyrene, a copolymer of polyvinyl pyrrolidone and polystyrene, dextran, mucopolysaccharide, xanthan, hydroxypropyl cellulose, methyl cellulose, hyaluronic acid, polyacrylic acid, polymethacrylic acid, polyhydroxyethyl methacrylate, chitosan, polyethylene imine, polyacrylamide, polyethylene glycol, polylactic acid, polystyrene sulfonic acid, polyanetholesulfonic acid, spermine, spermidine, putrescine, collagen, elastin, fibronectin, polysarcosine, poly(2-methacryloyloxyethyl phosphorylcholine) (PMPC), and heparin.

According to some preferred embodiments of the present disclosure, the hydrophilic layer 40 is a layer of polysarcosine, PMPC, or heparin. In case of the hydrophilic layer 40 being a layer of polysarcosine, the hydrophilic layer 40 is formed by polymerizing a plurality of sarcosine-N-carboxyanhydride (Sar-NCA) monomers, thereby forming a layer of polysarcosine. Alternatively, in case of the hydrophilic layer 40 being a layer of PMPC, the hydrophilic layer 40 is formed by polymerizing a plurality of 2-methacryloyloxyethyl phosphorylcholine (MPC) monomers, thereby forming a layer of PMPC. Alternatively or in addition, in case of the hydrophilic layer 40 being a layer of heparin, the hydrophilic layer 40 is formed by polymerizing a plurality of disaccharide units selected from the group consisting of 2-O-sulfo-α-L-iduronic acid and 2-deoxy-2-sulfamido-α-D-glucopyranosyl-6-O-sulfate (IdoA(2S)-G1cNS(6S)); β-D-glucuronic acid and 2-deoxy-2-acetamido-α-D-glucopyranosyl (G1cA-G1cNAc); β-D-glucuronic acid and 2-deoxy-2-sulfamido-α-D-glucopyranosyl (G1cA-G1cNS); α-L-iduronic acid and 2-deoxy-2-sulfamido-α-D-glucopyranosyl (IdoA-G1cNS); 2-O-sulfo-α-L-iduronic acid and 2-deoxy-2-sulfamido-α-D-glucopyranosyl (IdoA(2S)-G1cNS); and α-L-iduronic acid and 2-deoxy-2-sulfamido-α-D-glucopyranosyl-6-O-sulfate (IdoA-G1cNS (6S)).

Additionally or optionally, prior to coating each recesses (50a, 50b, and etc.) with a hydrophilic polymer, the surface of each recesses (50a, 50b, and etc.) may be treated with an amino silane, so as to confer the surface of each recess with amino groups, which may facilitate the coating of the subsequent hydrophilic layer 40. Examples of the amino silane suitable for use in the present disclosure include, but are not limited to, (3-aminopropyl)triethoxysilane (APTES), (3-aminopropyl)trimethoxysilane (APTMS), N-(2-aminoethyl)-3-aminopropyltrimethoxysilane (AE-APTMS), bis[(3-triethoxysily)propyl]amine, bis[(3-trimethoxysilyl)propyl]amine, 3-aminopropylmethyldiethoxysilane, 3-aminopropylmethyldimethoxysilane, N-[3-(trimethoxysilyl)propyl]ethylenediamine (DAS), aminoethylaminopropyltriethoxysilane, aminoethylaminopropylmethyldimethoxysilane, aminoethylaminopropylmethyldiethoxysilane, aminoethylaminomethyltriethoxy silane, aminoethylaminomethylmethyldiethoxysilane, diethylenetriaminopropyltrimethoxysilane, diethylenetriaminopropyltriethoxysilane, diethylenetriaminopropylmethyldimethoxysilane, diethyleneaminomethylmethyldiethoxysilane, (N-phenylamino)methyltrimethoxysilane, (N-phenylamino)methyltriethoxysilane, (N-phenylamino)methylmethyldimethoxysilane, (N-phenylamino)methylmethyldiethoxysilane, 3-(N-phenylamino)propyltrimethoxysilane, 3-(N-phenylamino)propyltriethoxysilane, 3-(N-phenylamino)propylmethyldimethoxysilane, 3-(N-phenylamino)propylmethyldiethoxysilane, and N-(N-butyl)-3-aminopropyltrimethoxysilane. In one working example, the surface of each recess is treated with APTMS prior to the formation of the hydrophilic layer 40 thereon.

According to embodiments of the present disclosure, each of the plurality of assay wells 50 is about 1-1,000 μm in diameter, such as 1, 5, 10, 20, 30, 40, 50, 60, 70, 80, 90, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 20 460, 470, 480, 490, 500, 510, 520, 530, 540, 550, 560, 570, 580, 590, 600, 610, 620, 630, 640, 650, 660, 670, 680, 690, 700, 710, 720, 730, 740, 750, 760, 770, 780, 790, 800, 810, 820, 830, 840, 850, 860, 870, 880, 890, 900, 910, 920, 930, 940, 950, 960, 970, 980, 990, or 1,000 μm in diameter; preferably, about 5-500 μm in diameter, such as 5, 10, 20, 30, 40, 50, 60, 70, 80, 90, 100, 110, 120, 130, 140, 150, 160, 170, 180, 190, 200, 210, 220, 25 230, 240, 250, 260, 270, 280, 290, 300, 310, 320, 330, 340, 350, 360, 370, 380, 390, 400, 410, 420, 430, 440, 450, 460, 470, 480, 490, or 500 μm in diameter; more preferably, about 5-50 μm in diameter, such as 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 μm in diameter. In some examples, each assay well is about 30 μm in diameter. In other examples, each assay well is about 100 μm in diameter. In further examples, each assay well is about 500 μm in diameter. According to preferred embodiments of the present disclosure, the present device 1 may include at least 4 assay wells (such as 4-96 assay wells) in its structure.

Further, each of the plurality of assay wells 50 has an aspect ratio of 1:0.1-1:2, such as 1:0.1, 1:0.2, 1:0.3, 1:0.4, 1:0.5, 1:0.6, 1:0.7, 1:0.8, 1:0.9, 1:1, 1:1.1, 1:1.2, 1:1.3, 1:1.4, 1:1.5, 1:1.6, 1:1.7, 1:1.8, 1:1.9, 1:2.

The present disclosure also encompasses a method for reducing the volume of an aquatic sample by use of the present device described above. The method includes the steps of,

(a) applying the aquatic sample onto each of the plurality of assay wells of the device; and

(b) concentrating the aquatic sample for a sufficient period of time, thereby resulting in reducing the volume of the aquatic sample;

wherein

the aquatic sample is labeled with a fluorescence dye or a fluorescent nanomaterial.

Optionally, the concentrated aquatic sample of step (b) may be directly viewed by any one of a reflection microscope, a transmission microscope, a fluorescence microscope, an upright microscope, an inverted microscope, a dark-field microscope, a confocal microscope, a standing wave confocal microscope, a reflection contrast microscope, or a fluorescence scanner.

The aquatic sample suitable for being concentrated by the present device may be an aquatic sample of any kind, especially for those aquatic samples that are labeled (or mixed) with fluorescence dyes or fluorescent nanomaterials, or the aquatic samples are fluorescent per se, as the aquatic sample tends to flow into the hydrophilic well when applied onto the device, which further facilitates the concentration thereafter. Preferably, the aquatic sample may be a biological sample isolated from a subject (e.g., a mammal; preferably, a human), and the biological sample may be blood, plasma, serum, saliva, sputum, urine, or tissue lysate. Preferably, the fluorescence dye suitable for use in labeling the aquatic sample is selected from the group consisting of N-hydroxysuccinimide (NHS) ester (ATTO425, ATTO647, ATTO655), maleimide (ATTO550, ATTO647N), biotin (ATTO565), phosphoramidite (CALFluorGold540, Quasar570, Quasar670), amidite (CALFluorOrange560, Quasar705), carboxylic acid (CALFluorRed590), 6-carboxyfluorescein (6-FAM), 6-carboxy-X-rhodamine (ROX), rhodamine 6G (R6G), cyanine 3 (Cy3), cyanine 3.5 (Cy3.5), cyanine 5 (Cy5), cyanine 5.5 (Cy5.5), 5′-dichloro-dimethoxy-fluorescein (JOE), fluorescein, hexachloro-10 fluorescein (HEX), succinimidyl ester (AlexaFluor350), tetrachloro-fluorescein (TET), tetramethylrhodamine (TAMRA), Texas red, Victoria (VIC), and Yakima yellow. Said fluorescent nanomaterial as used herein refers to a material (preferably, an aquatic nanomaterial) that is labeled with fluorescence dyes (such as a fluorescent probe (e.g., the present MB), fluorescent water, fluorescent PBS) or a material with self-emitted fluorescence (such as fluorescent nanoparticles, fluorescent nanoclusters, carbon quantum dots, copper germanium sulfide quantum dots, antimony-containing organic-inorganic perovskite quantum dots, gold quantum dots, cadmium telluride quantum dots, lead sulfide quantum dots, cadmium selenide/zinc sulfide quantum dots, zinc cadmium selenide/zinc sulfide quantum dots, cadmium selenide/cadmium sulfide quantum dots, zinc selenide/zinc sulfide quantum dots, cadmium selenide sulfide quantum dots, or cadmium sulfide quantum dots).

In addition, the volume of the aquatic sample before concentrating via use of the present device may be in microliter (μl) level, for example, 0.1-50 μl, such as 0.1, 0.2, 0.3, 0.4, 0.5, 0.6, 0.7, 0.8, 0.9, 1, 1.5, 2, 2.5, 3, 3.5, 4, 4.5, 5, 5.5, 6, 6.5, 7, 7.5, 8, 8.5, 9, 25 9.5, 10, 15, 20, 25, 30, 35, 40, 45, or 50 μl. In one working example, the volume of the aquatic sample before concentrating is 2 μl. In another working example, the volume of the aquatic sample before concentrating is 4 μl. The volume of the aquatic sample after concentrating via the present device may be in picoliter (pl) level, for example, 0.1-50 pl, such as 0.1, 0.2, 0.3, 0.4, 0.5, 0.6, 0.7, 0.8, 0.9, 1, 1.5, 2, 2.5, 3, 3.5, 4, 4.5, 5, 5.5, 6, 6.5, 7, 7.5, 8, 8.5, 9, 9.5, 10, 15, 20, 25, 30, 35, 40, 45, or 50 pl.

For the step (b), any method capable of reducing the volume of the aquatic sample may be adopted, which includes, but is not limited to, evaporation, heating, or vacuum concentration.

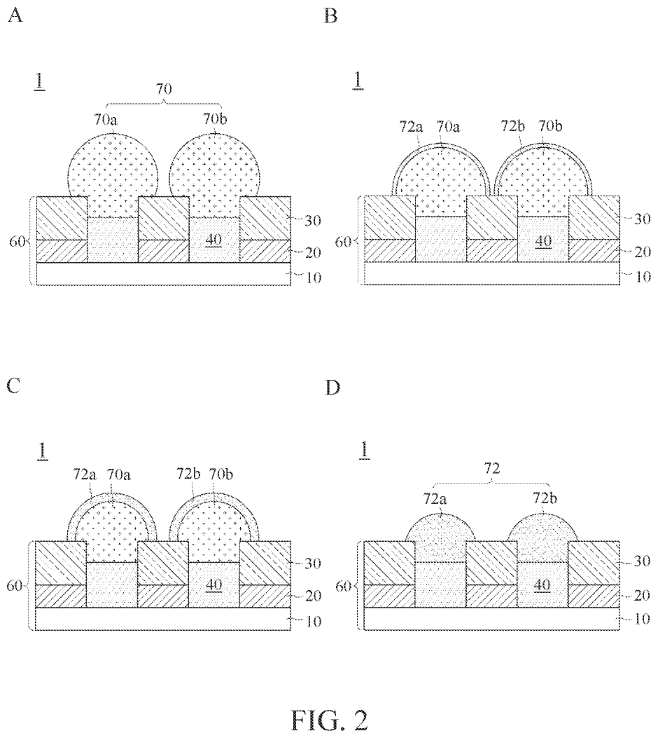

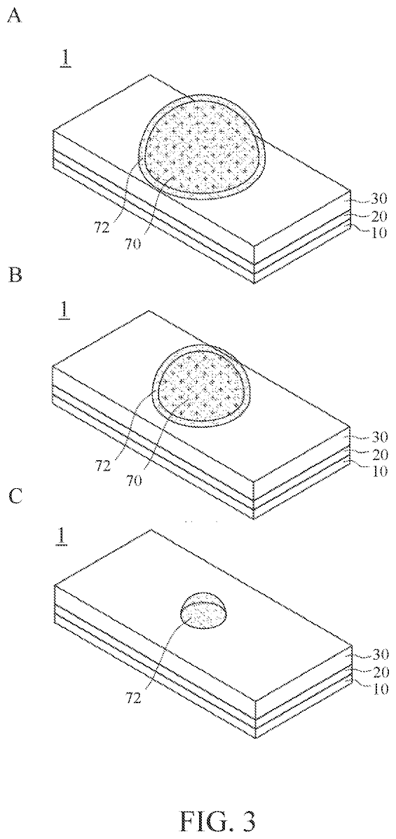

Reference is made to FIGS. 2-3, which illustrate the process for concentrating an aquatic sample by the present device, in which FIG. 2 is a cross-sectional view and FIG. 3 is a perspective view, independently depicts the change of the volume of and the fluorescence emitted from the fluorescent aquatic sample. To start with, each fluorescent aquatic sample 70 (including 70a, 70b, and etc.) is dripped onto an assay well; at this stage, barely any fluorescence was is emitted from the aquatic sample due to the extremely low concentration of fluorophores (FIG. 2, panel A). With the proceeding of the concentration process, the volume of the aquatic sample 70 starts to decrease and the concentration of the aquatic sample 70 increases, allowing the fluorescence 72 (including 72a, 72b, and etc.) therefrom to be detected (FIG. 2, panels B and C, and FIG. 3, panels A and B). By the end of concentration process, the volume of the aquatic sample 70 reaches its minimum, and the concentration of the aquatic sample 70 reaches its maximum, resulting in the maximum emission of fluorescence 72 (including 72a, 72b, and etc.) (FIG. 2, panel D, and FIG. 3, panel C).

2. The Kit and Uses Thereof

Another aspect of the present disclosure is directed to kits and methods for detecting a target nucleic acid in a biological sample isolated from a subject. The kit includes, at least, the present device described above, and a lipoplex, wherein the lipoplex comprises a liposome and a MB embedded in the liposome, wherein the MB is labeled with a fluorescence dye and a quencher.

Details of the present device are as described above; for the sake of brevity, the description thereof will not be repeated. With regards to the liposome, it would be appreciated that the liposome may be made of any suitable lipids, with the molar ratio of the lipids capable of being adjusted as needed. Alternatively or additionally, the liposome may be positively charged (e.g., for preparation of a lipoplex) or being neutral in charges (e.g., for preparation of an artificial EV) via mixing proper types of lipids until a desired final charge is reached. Non-limiting examples of the lipids suitable for making the liposome include natural phospholipids, phosphatidylcholine, phosphatidylserine, phosphatidylethanolamine, phosphatidylinositol, phosphatidylglycerol, polyethylene glycol (PEG), poly(lactic-co-glycolic acid) (PLGA), polyethylene glycol-poly lactic acid-co-glycolic acid (PEG-PLGA), linoeic acid (LA), cholesterol, 1,2-Dimyristoyl-rac-glycero-3-methoxypolyethylene glycol-2000 (DMG-PEG2000), 1,2-dioleoyl-sn-glycero-3-phosphate (DOPA), 1,2-dioleoyl-sn-glycero-3-phosphocholine (DOPC), DOPE (1,2-dioleoyl-sn-glycero-3-phosphoethanolamine), 1,2-dioleoyl-sn-glycero-3-phosphoethanolamine-N-[methoxy(polyethylene glycol)-2000](DOPE-PEG2000), 1,2-dioleoyl-3-trimethylammonium-propane (DOTAP), 1,2-Distearoyl-sn-Glycero-3-Phosphoethanolamine (DSPE), 1,2-distearoyl-sn-glycero-3-phosphoethanolamine-N-[methoxy(polyethylene glycol)-2000] (DSPE-PEG), and 1,2-distearoyl-sn-glycero-3-phosphoethanolamine-N-(polyethylene glycol)-thiol (DSPE-PEG-SH or SH-PEG-DSPE). The liposome may be prepared via any suitable method known to the art. In one working example, the liposome having a net positive charge is made by mixing DOPC, DOTAP, cholesterol, and SH-PEG-DSPE in the molar ratio of 28:40:30:2. In another working example, the liposome having a net neutral charge is made by mixing DOPE, LA, and DMG-PEG2000 in the molar ratio of 50:49:1.

The MB for use in the present invention is labeled with a fluorescence dye at one end and a quencher at the other end. The fluorescence dye suitable for labeling the MB may be N-hydroxysuccinimide (NHS) ester (ATTO425, ATTO647, ATTO655), maleimide (ATTO550, ATTO647N), biotin (ATTO565), phosphoramidite (CALFluorGold540, Quasar570, Quasar670), amidite (CALFluorOrange560, Quasar705), carboxylic acid (CALFluorRed590), 6-carboxyfluorescein (6-FAM), 6-carboxy-X-rhodamine (ROX), rhodamine 6G (R6G), cyanine 3 (Cy3), cyanine 3.5 (Cy3.5), cyanine 5 (Cy5), cyanine 5.5 (Cy5.5), 5′-dichloro-dimethoxy-fluorescein (JOE), fluorescein, hexachloro-fluorescein (HEX), succinimidyl ester (AlexaFluor350), tetrachloro-fluorescein (TET), tetramethylrhodamine (TAMRA), Texas red, Victoria (VIC), or Yakima yellow. In one working example, the MB is labeled with 6-FAM at one end.

As to the quencher, the choice of quencher varies with the fluorescent dye that used, so that the quencher may quench the fluorescence appropriately. Examples of the quencher includes black hole quencher 1 (BHQ1), black hole quencher 2 (BHQ2), black hole quencher 3 (BHQ3), minor groove binder (MGB), nonfluorescent quencher (NFQ), Dabcyl (4-(4′-dimethylaminophenylazo)benzoic acid), onyx quencher A (OQA), onyx quencher B (OQB), onyx quencher C (OQC), and onyx quencher D (OQD). In one working example, the MB is labeled with the quencher BHQ1 at one end, and the fluorescent dye 6-FAM at the other end. In another working example, the MB is labeled with the quencher BHQ2 at one end, and the fluorescent dye 6-FAM at the other end.

The MB is designed to be complementary to the target gene, thus may bind with the target gene via hybridization. Since the MB serves as a probe, thus, as long as it could bind to, and therefore detect the target gene, there is no specific limitation to its sequence per se. The skilled artisan may recognize that many MB s are commercially available and may be used in the methods of the present invention. A detailed discussion on the criteria for designing effective MB nucleotide sequences may be found in literature. Design of the MB is usually done with the aid of a software, such as ‘Beacon Designer,’ which is available from Premier Biosoft International (Palo Alto, CA, USA), Oligo (Molecular Biology Insights, Inc., Cascade, CO, USA), and the like. In one working example, the MB comprises a nucleic acid sequence of SEQ ID NO.: 2 that binds to miR-21 (SEQ ID NO.: 1), thus results in the detection of miR-21. In another working example, the MB comprises a nucleic acid sequence of SEQ ID NO.: 5 that binds to TTF-1 (SEQ ID NO.: 4), thus results in the detection of TIF-1.

The preparation of the lipoplex (i.e., the positively charged liposome containing the MB therein) is known to the art. In general, the lipoplex is prepared by adding the MB (dissolved in an appropriate solvent, such as phosphate buffered saline (PBS)) into a solution containing the positively charged liposome at the needed ratio, subjecting the mixture to ultrasonication; then, the sonicated mixture is diluted with an appropriate solvent (e.g., PBS) at the needed ratio, and homogenized to produce the desired lipoplex. Alternatively or additionally, the ultrasonication and/or homogenization steps may be repeated according to the needs. It would be appreciated that the MB may be used alone (i.e., in a form without encapsulated within the liposome) with the present device, and therefore the kit of such kind (i.e., the MB alone plus the present device) is also encompassed within the scope of the present disclosure.

Alternatively or in addition, the present disclosure also provides a method for detecting a target nucleic acid in a biological sample isolated from a subject by using the kit as set forth above. The method comprises the steps of,

(a) mixing the lipoplex with the biological sample;

(b) applying the mixture of the step (a) onto each of the plurality of assay wells of the device; and

(c) reducing the volume of the mixture disposed in each of the plurality of assay wells of the step (b) via evaporation, heating, or vacuum concentration;

wherein

the fluorescence signal emitted from the MB indicates the presence of the target nucleic acid within the biological sample.

The following Examples are provided to elucidate certain aspects of the present invention and to aid those of skilled in the art in practicing this invention. These Examples are in no way to be considered to limit the scope of the invention in any manner. Without further elaboration, it is believed that one skilled in the art can, based on the description herein, utilize the present invention to its fullest extent. All publications cited herein are hereby incorporated by reference in their entirety.

### EXAMPLES

### Materials and Methods

### Preparation of the Nucleic Acids/the Positively Charged Liposomes/the Lipoplexes

The following nucleic acids, including the MBs, the target genes, and the control molecular beacons (i.e., the scramble MBs, scMBs), were dissolved in ddH₂O to give a final concentration of 100 μM, respectively. The sequences of the MBs, the target gene fragments, and the control molecular beacons (scMBs) are provided in Table 1.

TABLE 1
The nucleic acids used in the present study

| | | SEQ |
|---|---|---|
| Name | Sequence (5′-3′) | ID NO. |
| miR-21 | TAGCTTATCAGACTGATGTTG | 1 |
| miR-21_MB | CGCGATCTCAACATCAGTCTGATAAGCTAGA | 2 |
| | TCGCG | |
| miR-21_scMB | CGCGATCTCTACTTCTGTGTGTAATGCAAGA | 3 |
| | TCGCG | |
| TTF-1 | TTCTACAGTCTGTGACTCTTG | 4 |
| TTF-1_MB | CGCGATCCAAGAGTCACAGACTGTAGAAGAT | 5 |
| | CGCG | |
| TTF-1_scMB | CGCGATCCATGACTCTCACAGTGAAGATGAT | 6 |
| | CGCG | |

miR-21: target nucleic acid.
miR-21_MB: MB that hybridizes with miR-21 target nucleic
acid.
miR-21_scMB: scramble MB that does not hybridize with
miR-21 target nucleic acid.
TIF-1: target nucleic acid.
TIF-1_MB: MB that hybridizes with TIF-1 target nucleic
acid.
TIF-1_scMB: scramble MB that does not hybridize with TIF-1
target nucleic acid.

The miR-21_MB, the miR-21_scMB, the TTF-1_MB, and the TTF-1_scMB were independently labeled with a fluorescence dye 6-FAM at its 5′ terminal end and a quencher BHQ1 at its 3′ terminal end, while the miR-21 fragment and the TTF-1 fragment remained unlabeled. For the purpose of comparison of the efficiency of each quenchers in quenching 6-FAM, another miR-21_MB was additionally labeled with a fluorescence dye 6-FAM at its 5′ terminal end and a quencher BHQ2 at its 3′ terminal end. According to unpublished data, as compared to BHQ2, BHQ1 exhibited better quenching efficiency in quenching the fluorescence emission of 6-FAM (data not shown).

### Preparation of Positively Charged Liposomes

The positively charged liposomes for later use in preparing lipoplexes were prepared by mixing 1,2-dioleoyl-3trimethylammoniumpropane (DOTAP) (in 99% anhydrous alcohol), cholesterol (in 99% anhydrous alcohol), and 1,2-distearoyl-sn-glycero-3-phosphoethanolamine-N-(polyethylene glycol)-thiol (SH-PEG-DSPE) (in 99% anhydrous alcohol), to make the final molar ratio of the three ingredients being 49:49:2. The positively charged liposomes were stored at 4° C. for later use.

### Preparation of Lipoplexes

For preparing the lipoplexes, the miR-21 MB and the miR-21 fragment, or the TTF-1 MB and the TTF-1 fragment, were added into 1×DPBS to make up a first mixture (about 30 μl in total). The first mixture was quickly injected into the liposome (20 μl) to make up a second mixture (about 50 μl in total), and then subjected to ultrasonic sonication for 5 minutes. Subsequently, the second mixture was quickly injected into lx DPBS (450 μl), homonized for 10 seconds, and then subjected to ultrasonic sonication for 5 minutes. The resulting crude mixture (about 500 μl in total) contained the lipoplexes.

The crude mixture (containing the lipoplexes) was purified by dripping into a 100 kDa ultra-centrifuge tube and centrifuging at 4500 r.p.m. for 20 minutes, and the supernatant (i.e., the purified mixture) was collected for later use.

### Preparation of the Neutrally Charged Liposomes Containing the Target Gene Fragments

To mimic the compositions of the natural EV counterparts, neutrally charged liposomes (nLPs) containing target gene fragments were prepared and were used in subsequent experiments. Note that natural EVs were substantially comprised of nLPs, nucleic acids, and other molecules within the nLPs, thereby rendering the entire complexes being negatively charged. For the preparation of the nLPs, 1,2-dioleoyl-sn-glycero-3-phosphoethanolamine (DOPE) (in 99% anhydrous alcohol), linoeic acid (LA) (in 99% anhydrous alcohol), and 1,2-Dimyristoyl-rac-glycero-3-methoxypolyethylene glycol-2000 (DMG-PEG2000) (in 99% anhydrous alcohol) were mixed, to make the final molar ratio of the three ingredients being 50:49:1.

Then, the miR-21 fragments and the miR-21 scMBs, or the TTF-1 fragments and the TTF-1 scMBs, were added into lx DPBS to make up a first mixture (about 36 μl in total). The first mixture was quickly injected into the nLPs (24 μl) to make up a second mixture (about 60 μl in total), and then the entire mixture was subjected to ultrasonification for 5 minutes. Subsequently, the second mixture was quickly injected into 1×DPBS (540 μl), homogenized for 10 seconds, and then ultrasonicated for 5 minutes. The resulting crude mixture (about 600 μl in total) was nLPs containing target nucleic acids (i.e., miR-21 or TTF-1) therein.

The crude mixture was purified by dripping into a 10 kDa dialysis column and eluting with PBS for 1 hour and again for overnight, and the supernatant (i.e., the purified mixture) was collected for later use.

### Characterization of the Lipoplexes, the nLPs Containing Target Nucleic Acids, and the EVs

The lipoplexes, the nLPs containing target nucleic acids, the EVs were subjected to nanoparticle tracking analysis (NTA) and dynamic light scattering analysis (DLS) for their particle sizes, and to zeta potential analysis for their electrical properties.

### Example 1 Construction of the Present Device

### 1.1 Formation of Multi-Layer Structures on a Glass Substrate

An ultra-thin cover glass was used as a substrate for construction of the present device. The cover glass was cleansed by treating in sequence with ddH₂O, 70% alcohol, and First Contact™ cleaning solution; then, the glass was subjected to UV radiation first at 185 nm, then at 254 nm so as to modify its surface with hydroxy groups. Then, the modified cover glass was sputter deposited with gold atomsunder a current intensity of 20 mA, thus forming a layer of gold about 20 nm in thickness on top of the modified cover glass.

Subsequently, the cover glass having a layer of gold deposited thereon was spin coated with a fluoropolymer—CYTOP™ (BELLEX International Corp., DE, USA) (diluted in CT-SOLV180 with the concentration of 3%, 5%, 7%, and 9%) to form a hydrophobic layer. The spin coating was performed in two stages; in the first stage, the cover glass having a layer of gold atoms deposited thereon was spin coated with CYTOP™ at 1500 r.p.m. to let CYTOP™ be coated evenly thereon; and in the second stage, the cover glass of the first stage was spin coated with CYTOP™ at 3500 r.p.m., 4500 r.p.m., 5500 r.p.m., or 7500 r.p.m., so as to form the hydrophobic layer of various thicknesses. After spin coating, the resulting structure was let stand for 15 to 30 minutes before being heated first at 80° C. for 30-60 minutes, and then at 200° C. for additional 30-60 minutes.

### 1.2 Formation of Multi-Recesses on the Multi-Layer Structure of Example 1.1

The multi-layer structure of Example 1.1 was subjected to UV laser etching to create a plurality of micro-recesses within the fluoropolymer layer. The etching was performed by use of an UV laser etching instrument (or UV Maker) with the output wavelength being set at 355 nm, the maximum wattage being set at 3 W, and the maximum working area being 7 cm². The process was done by plotting the etching pattern, and performed the etching under the parameters of: the speed 300 mm/s, the frequency 300 kHz, and the pulse width 2 μs, and the power ranged from 48-80%. The multi-recesses were respectively about 30 μm, 100 μm, 500 μm, or 1 mm in diameter; and about 0.5 μm, 3 μm, 4 μm, or 5 μm in depth. After laser etching, the diameter and the depth of the micro-recesses was respectively determined by dark field microscope and scanning with an atomic force microscope.

### 1.3 Coating Each recesses with a Layer of Polysarcosine

Each recesses of the multi-layer structure of Example 1.2 was treated with 60 mM 3-aminopropyl trimethoxysilane (APTMS) in ethanol for 2 hours at 80° C. to confer the surface of each recesses with amino groups. Then, 1 mM sarcosine-N-carboxyanhydride (Sar-NCA) in benzonitrile (BN)/triethylamine (TEA) (1:0.1 (v/v)) was added into each recesses and incubated for 48-72 hours, thereby resulted in the formation of a layer of polysarcosine within each recesses. The formation of the polysarcosine in each recesses concluded the construction of the present device.

### 1.4 Coating Each Recesses with a Layer of PMPC

Alternatively, each recesses of the multi-layer structure of Example 1.2 was treated with 60 mM APTMS for 1 hour at 80° C., and subsequently with bromoisobutyrl bromide (BIBB) overnight at 25° C. before being washed with ddH₂O/methanol (1:1 (v/v)). As a result, the surface of each recesses was conferred with bromine groups, which would facilitate the formation of the subsequent layer of poly(2-methacryloyloxyethyl phosphorylcholine) (PMPC). To form PMPC layer, PMPC solution (0.25 g MPC, 0.004 g cuprous bromide, 0.009 g bypiridine, dissolved in lml methanol) was added to each recesses, and incubated for 4-8 hours, and then washed with methanol. The formation of the PMPC layer in each recesses concluded the construction of the present device.

### Example 2 Characterization of the Device of Example 1

### 2.1 The Hydrophobicity of the Coated CYTOP™ Layer

The multi-layer structures of Example 1.1 respectively spin coated with 3%, 5%, 7%, or 9% CYTOP™ were subjected to contact angle analysis so as to verify the hydrophobicity of each CYTOP™ layer coated thereon.

To this purpose, water droplet (4 μl) was applied onto the surface of each structure before and after spin coating the layer of CYTOP™. It was found that the contact angle for the water droplet on the structures coated with 3%, 5%, 7%, or 9% CYTOP™ was 104.31°, 109.63°, 109.87°, or 104.98° (data not shown); while the contact angle for the water droplet before coating was 45.33° (data not shown). As the contact angles did not differ too much among structures respectively coated with 3 to 9% CYTOP™, 3% CYTOP™ was adopted for the construction of the present device in subsequent studies.

### 2.2 The Thickness of the Coated CYTOP™ Layer and the Depth of the Each Recesses

Each recesses in the multi-layer structure of Example 1.2 was subjected to thickness and depth analysis, and the results are summarized in Tables 2 and 3.

TABLE 2
The effect of the rotating speed in the spin coating process on the
thickness of the CYTOP ™ layer

| Rotating speed | Thickness of the CYTOP ™ layer |
|---|---|
| 3500 r.p.m. | 5 μm |
| 4500 r.p.m. | 4 μm |
| 5500 r.p.m. | 3 μm |
| 7500 r.p.m. | 0.5 μm |

TABLE 3
The effect of the power of the laser
etching on the depth of the recesses

| Thickness | | | | | | |
|---|---|---|---|---|---|---|
| of the | Power | | | | | |
| CYTOP ™ | 80% | 70% | 60% | 55% | 50% | 48% |
| layer | Depth of the micro-wells | | | | | |
| 5 μm | 5 μm | 4 μm | 2 μm | 0.4 μm | 0.3 μm | 0.2 μm |
| 4 μm | 4 μm | 4 μm | 2 μm | x | x | x |
| 3 μm | 3 μm | 3 μm | 2 μm | x | x | x |
| 0.5 μm | 0.5 μm | 0.5 μm | x | x | x | x |

It was found that the power of the laser etching significantly affected the depth of each recess, which was also limited by the thickness of the hydrophobic CYTOP™ layer. Accordingly, by adjusting the power of the laser etching instrument and the rotating speed in the spin coating treatment, the present device with micro-recesses of desired depth may be constructed.

### 2.3 The Hydrophilicity of Polysarcosine Layer of the Device of Example 1.3

The hydrophilicity of the polysarcosine in each recesses of the device of Example 1.3 was verified by contact angle analysis. Water droplet (4 μl) was applied onto the surface of each recess before and after coating the layer of polysarcosine. It was found that the contact angle for the water droplet on the surface of each recesses before coating was 46.95°, while the contact angle for the water droplet on the surface of each recesses after amino group modification (i.e., having amino groups present on the surface of each recess) was decreased to 37.41°, and the contact angle for the water droplet on the surface of each recesses after coating was significantly dropped to 12.40° or 17.49° (data not shown). In the meanwhile, the contact angles of the surface surrounding each recess before and after coating were 109.35° and 108.87°, respectively, suggesting coating of the polysarcosine layer did not affect the hydrophobicity of the area surrounding the each recess (data not shown).

### Example 3 Reducing the Volume of a Fluorescent Sample with the Aid of the Device of Example 1.3

### 3.1 Rhodamine 6G (R6G)

In this example, rhodamine 6G (R6G) was used as an aquatic sample to investigate the concentrating effect of the device of Example 1.3. To this purpose, a device having a plurality of assay wells (or recesses) in various diameter was constructed; the device was coated with a CYTOP™ layer that was about 5 μm in thickness (i.e., formed by spin coating at 3500 r.p.m.), and the assay wells (or recesses) were about 1 mm, 500 μm, 100 μm, or 30 μm in diameter, and 5 μm in depth (i.e., formed by laser etching at the power of 80%).

R6G was serially diluted (from 20 ng/ml to 2 pg/ml, 2 μl sample/test) and small droplets of each diluted R6G solution were added to the assay wells of the chosen device. Let the devices stayed in a humid atmosphere in a petri-dish or heated in an oven for 30 minutes, in which 0.0001 μl of glycerol was added to the petri-dish. The fluorescent signal within each assay wells was detected by a traditional fluorescence spectrometer.

It was found that the fluorescence signal was significantly enhanced in the device with assay wells independently about 100 μm or 30 μm in diameter, as compared to that of assay wells independently about 1 mm or 500 μm in diameter (no obvious signal enhancement effect), suggesting that the magnification of the fluorescence intensity was markedly enhanced by the reduction in the volume of R6G sample (data not shown). The magnification of the fluorescence intensity was found to be proportional to its initial concentration. In the device with the CYTOP™ layer about 0.5 μm in thickness (i.e., formed by spin coating at 7500 r.p.m.), the assay wells independently about 0.5 μm in depth (i.e., formed by laser etching at the power of 80%), and about 100 μm, or 30 μm in diameter, it was found that the sample tended to flow toward the assay wells during the reduction of sample volume process (data not shown).

The results confirmed that the sample could be successfully concentrated within the assay wells of the present device.

### 3.2 Molecular Beacons (MBs)

In this example, the MB without being labeled with a quencher was serially diluted (from 781 nM to 6.2 nM, including 781 nM, 390 nM, 196 nM, 98 nM, 49 nM, 25 nM, 12.5 nM, and 6.2 nM; 2 μl sample/test), and each sample was concentrated in accordance with similar procedures described in Example 3.1.

It was found that the magnification of the fluorescence intensity of the MB samples was correlated to its initial concentration in a dose-dependent manner. Further, it was found that the fluorescence intensity was significantly enhanced in the device with assay wells independently about 30 μm in diameter, as compared to that of assay wells independently about 100 μm in diameter (the MB in concentration of 12.5 nM was used in this batch of experiment).

### 3.3 Mixtures of the Lipoplexes and the the nLPs Containing miR-21

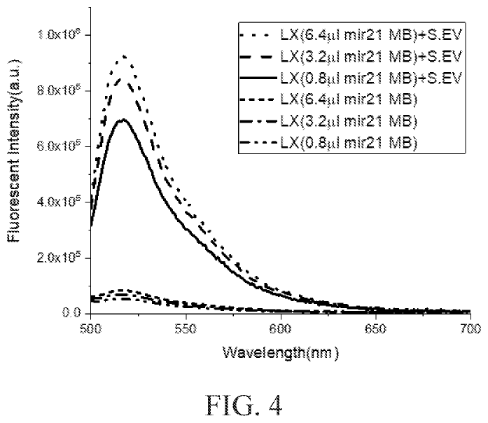

In this example, the lipoplexes containing the miR-21 MB at the volume of 6.4 μl, 3.2 μl, or 0.8 μl were independently mixed (“the mixture groups”) or not mixed (“the control groups”) with the nLPs containing miR-21 before being subjected to concentration, and each sample (2 μl sample/test) was concentrated in accordance with similar procedures described in Example 3.1, in which the present device with assay wells independently about 30 μm in diameter as described in Example 3.1 was used in the experiment, and the results are depicted in FIG. 4.

According to the data presented in FIG. 4, significant fluorescence intensity was detected in the mixture groups, as compared to that in the control groups. Taken together, the data indicated that: (1) the lipoplexes were fused with the nLPs, and the miR-21 MBs in the lipoplexes were bound to its target miR-21 in the nLPs; and (2) the fluorescence emitted from the miR-21 MB was significantly magnified after the sample was concentrated with the aid of the present device, allowing the fluorescence to be readily detected by a fluorescence spectrometer.

In sum, the present invention provides novel devices that can be used in reducing the volume of a sample from microliter level to picoliter level, thereby allowing the matters-of-interest in the sample to be concentrated up to ten thousand times or more. The present invention is highly useful for the enhancement of trace signals, particularly for detecting biomarkers (e.g., nucleic acids and/or proteins in humans' circulation) that are present in trace amounts. Detection sensitivity for the biomarker may be greatly improved with the aid of the present invention.

It will be understood that the above description of embodiments is given by way of example only and that various modifications may be made by those with ordinary skill in the art. The above specification, examples and data provide a complete description of the structure and use of exemplary embodiments of the invention. Although various embodiments of the invention have been described above with a certain degree of particularity, or with reference to one or more individual embodiments, those with ordinary skill in the art could make numerous alterations to the disclosed embodiments without departing from the spirit or scope of this invention.

What is claimed is:

1. A device for reducing the volume of an aquatic sample, comprising:
a substrate;
a metal layer disposed above the substrate;
a hydrophobic layer disposed above the metal layer having a plurality of assay wells formed therein; and
a hydrophilic layer coated on each of the plurality of assay wells;
wherein
the aquatic sample tends to flow toward the plurality of assay wells and stay therein, thereby resulting in a reduction of the volume of the aquatic sample to picoliter level after concentrating the aquatic sample for a sufficient period of time.

2. The device of claim 1, wherein the metal layer is formed by sputter deposition the substrate with metal atoms derived from a metal selected from the group consisting of ruthenium (Ru), rhodium (Rh), palladium (Pd), osmium (Os), iridium (Ir), platinum (Pt), silver (Ag), copper (Cu), rhenium (Re), mercury (Hg), and gold (Au).

3. The device of claim 1, wherein the hydrophobic layer is formed by spin coating the substrate with a hydrophobic polymer, and the hydrophobic polymer is selected from the group consisting of polyethylene, poly(isobutene), poly(isoprene), poly(4-methyl-1-pentene), polypropylene, a copolymer of ethylene and propylene, a copolymer of ethylene, propylene, and hexadiene, a copolymer of ethylene and vinyl acetate, a copolymer of ethylene and butene, a copolymer of ethylene and octene, poly(styrene), poly(2-methylstyrene), poly(vinyl butyrate), poly(vinyl decanoate), poly(vinyl dodecanoate), poly(vinyl hexadecanoate), poly(vinyl hexanoate), poly(vinyl octanoate), poly(methacrylonitrile), poly(n-butyl acetate), poly(ethyl acrylate), poly(benzyl methacrylate), poly(n-butyl methacrylate), poly(isobutyl methacrylate), poly(t-butyl methacrylate), poly(t-butylaminoethyl methacrylate), poly(do-decyl methacrylate), poly(ethyl methacrylate), poly(2-ethylhexyl methacrylate), poly(n-hexyl methacrylate), poly(phenyl methacrylate), poly(n-propyl methacrylate), poly(octadecyl methacrylate), poly(ethylene terephthalate), poly(butylene terephthalate), polybutylene, polyacetylene, and fluoropolymer.

4. The device of claim 1, wherein the hydrophilic layer is formed by coating each of the plurality of assay wells with a layer of a hydrophilic polymer, and the hydrophilic polymer is selected from the group consisting of polyurethane, polyvinyl alcohol, polypropylene oxide, polyethylene oxide, polytetramethyl oxide, polyvinyl pyridine, polyvinyl pyrrolidone, polyacrylonitrile, polyacrylamide, a copolymer of polyvinyl pyrrolidone and polyvinyl acetate, sulfonated polystyrene, a copoplymer of polyvinyl pyrrolidone and polystyrene, dextran, mucopolysaccharide, xanthan, hydroxypropyl cellulose, methyl cellulose, hyaluronic acid, polyacrylic acid, polymethacrylic acid, polyhydroxyethyl methacrylate, chitosan, polyethylene imine, polyacrylamide, polyethylene glycol, polylactic acid, polystyrene sulfonic acid, polyanetholesulfonic acid, spermine, spermidine, putrescine, collagen, elastin, fibronectin, polysarcosine, poly(2-methacryloyloxyethyl phosphorylcholine) (PMPC), and heparin.

5. The device of claim 1, wherein each of the plurality of assay wells is formed by laser etching the hydrophobic layer thereby creating the well that is about 5-50 μm in diameter.

6. The device of claim 5, wherein the well has an aspect ratio of 1:0.1-1:2.

7. The device of claim 1, wherein the substrate is treated with a sulfur functional trialkoxy silane or with UV prior to being sputter deposited with the gold atoms.

8. The device of claim 7, wherein the sulfur functional trialkoxy silane is selected from the group consisting of 3-aminopropyltrimethoxysilane, 3-aminopropyltriethoxysilane, 3-mercaptopropyltrimethoxysilane, 3-mercaptopropyltriethoxysilane (MPTES), 3-aminopropyltrichlorosilane, and 3-mercaptopropyltrichlorosilane.

9. The device of claim 1, wherein the substrate is made from a material selected from the group consisting of silica, glass, ceramic, and a metal.

10. The device of claim 1, wherein the surface of each of the plurality of assay wells is treated with an amino silane prior to being coated with the hydrophilic layer.

11. The device of claim 10, wherein the amino silane is selected from the group selected from the group consisting of (3-aminopropyl)triethoxysilane (APTES), (3-aminopropyl)trimethoxysilane (APTMS), N-(2-aminoethyl)-3-aminopropyltrimethoxysilane (AE-APTMS), bis[(3-triethoxysily)propyl]amine, bis[(3-trimethoxysilyl)propyl]amine, 3-aminopropylmethyldiethoxysilane, 3-aminopropylmethyldimethoxysilane, N-[3-(trimethoxysilyl)propyl]ethylenediamine (DAS), aminoethylaminopropyltriethoxysilane, aminoethylaminopropylmethyldimethoxysilane, aminoethylaminopropylmethyldiethoxysilane, aminoethylaminomethyltriethoxysilane, aminoethylaminomethylmethyldiethoxysilane, diethylenetriaminopropyltrimethoxysilane, diethylenetriaminopropyltriethoxysilane, diethylenetriaminopropylmethyldimethoxysilane, diethyleneaminomethylmethyldiethoxysilane, (N-phenylamino)methyltrimethoxysilane, (N-phenylamino)methyltriethoxysilane, (N-phenylamino)methylmethyldimethoxysilane, (N-phenylamino)methylmethyldiethoxysilane, 3-(N-phenylamino)propyltrimethoxysilane, 3-(N-phenylamino)propyltriethoxysilane, 3-(N-phenylamino)propylmethyldimethoxysilane, 3-(N-phenylamino)propylmethyldiethoxysilane, and N-(N-butyl)-3-aminopropyltrimethoxysilane.

12. A method for reducing the volume of an aquatic sample by use of the device of claim 1, comprising:
(a) applying the aquatic sample onto each of the plurality of assay wells of the device; and
(b) concentrating the aquatic sample for a sufficient period of time, thereby resulting in reducing the volume of the aquatic sample;
wherein
the aquatic sample is labeled with a fluorescence dye or a fluorescent nanomaterial.

13. The method of claim 12, wherein the fluorescence dye is selected from the group consisting of N-hydroxysuccinimide (NHS) ester (ATTO425, ATTO647, ATTO655), maleimide (ATTO550, ATTO647N), biotin (ATTO565), phosphoramidite (CALFluorGold540, Quasar570, Quasar670), amidite (CALFluorOrange560, Quasar705), carboxylic acid (CALFluorRed590), 6-carboxyfluorescein (6-FAM), 6-carboxy-X-rhodamine (ROX), rhodamine 6G (R6G), cyanine 3 (Cy3), cyanine 3.5 (Cy3.5), cyanine 5 (Cy5), cyanine 5.5 (Cy5.5), 5′-dichloro-dimethoxy-fluorescein (JOE), fluorescein, hexachloro-fluorescein (HEX), succinimidyl ester (AlexaFluor350), tetrachloro-fluorescein (TET), tetramethylrhodamine (TAMRA), Texas red, Victoria (VIC), and Yakima yellow.

14. The method of claim 12, wherein the fluorescent nanomaterial is selected from the group consisting of fluorescent nanoparticles, fluorescent nanoclusters, carbon quantum dots, copper germanium sulfide quantum dots, antimony-containing organic-inorganic perovskite quantum dots, gold quantum dots, cadmium telluride quantum dots, lead sulfide quantum dots, cadmium selenide/zinc sulfide quantum dots, zinc cadmium selenide/zinc sulfide quantum dots, cadmium selenide/cadmium sulfide quantum dots, zinc selenide/zinc sulfide quantum dots, cadmium selenide sulfide quantum dots, and cadmium sulfide quantum dots.

15. The method of claim 12, wherein the concentration is performed by evaporation, heating, or vacuum concentration.

16. The method of claim 12, wherein the aquatic sample is a biological sample isolated from a subject, and the biological sample is selected from the group consisting of blood, plasma, serum, saliva, sputum, urine, and tissue lysate.

17. The method of claim 16, wherein the subject is a human.

18. The method of claim 12, wherein the concentrated aquatic sample of step (b) is analyzed by any one of a reflection microscope, a transmission microscope, a fluorescence microscope, an upright microscope, an inverted microscope, a dark-field microscope, a confocal microscope, a standing wave confocal microscope, a reflection contrast microscope, or a fluorescence scanner.
